(19) United States
(12) Patent Application Publication
(10) Pub. No.: US 2010/0263116 A1
(43) Pub. Date: Oct. 21, 2010

(54) Method and System to Add Multi-Mode Flush Capability to a Single Mode Flush Toilet

(76) Inventors: Scott David Pinizzotto, San Francisco, CA (US); Shao-Yu Peng, Huatan Township (TW)

Correspondence Address: SCHOX PLC, 500 3rd Street, Suite 515, San Francisco, CA, 94107, US

(21) Appl. No.: 12/758,692

(22) Filed: Apr. 12, 2010

Related U.S. Application Data
(60) Provisional application No. 61/168,385, filed on Apr. 10, 2009.

(51) Int. Cl. E03D 1/14; B23P 17/04

(52) U.S. Cl. 4/324; 29/401.1

(57) ABSTRACT

Disclosed is a system and method to convert a single flush toilet system to a multi-flush system. The system comprises of a flush selector that allows user selection of at least two flush modes, a flush water volume adjuster for each flush mode that allows the user to adjust the volume of water that flows from the water tank to flush the toilet bowl for each flush mode, a lifter that lifts the flapper of the toilet and allows water to flow from the water tank to flush the toilet bowl, and a hydraulic power source that powers the lifter to allow the adjusted volume of water to flow from the water tank to the toilet bowl and to flush the toilet bowl.

### TECHNICAL FIELD

This invention relates generally to the toilet flush field, and more specifically to a new and useful system and method in the field of selective flushing of a toilet.

### BACKGROUND

In a typical household, about 40% of all indoor water use is for the flushing of the toilet. To consistently provide the clean flush that is desirable by users with each flush and to minimize complexity, toilets generally provide one flush mode that uses an amount of water that is appropriate to provide a clean flush in most usage scenarios. More specifically, the same amount of water that is used for usage scenarios that require a relatively large amount of water for a clean flush (e.g., defecation or “poop”) is also used for usage scenarios that require a relatively small amount of water for a clean flush (e.g., urination or “pee”). Throughout the typical daily use of a toilet, usage scenarios that require a relatively small amount of water for a clean flush are more frequent than usage scenarios that require a relatively large amount of water for a clean flush. As a result, a significant amount of water that is used for flushing the toilet in a typical household is extraneously used.

Some toilets are specifically built to provide two modes of flushes, a “full” flush and a “half” flush, allowing the user to choose the appropriate flush for the type of usage scenario. However, such toilets are typically much more expensive than toilets that provide one mode of flush and may also require an electrical connection in order to operate. Additionally, most households are already equipped with a toilet that provides one mode of flush and the cost, labor, and environment factors required to replace the already existing toilet with a toilet that provides two modes of flushes is less than ideal.

Available systems that may be applied to existing single mode flush residential toilets are also typically difficult to install, require major changes to the anatomy of the toilet, and/or may not be compatible with most residential toilets. In a typical residential toilet, the user actuates a flush by pushing upon a lever that lifts the flapper of the toilet at the bottom of the water tank. Because of gravity, the water of the water tank will flow into the toilet blow, completing a flush. After the flush, the lower water level within the water tank starts a refilling of water into the water tank in preparation for the next flush and the flapper returns to the flapper seat and is kept sealed by the weight of the water until it is lifted once again. Residential toilets are equipped with a large variety of tank sizes, flapper actuation systems, flapper geometries, and/or flushing pressure. As a result, a half tank flush for one toilet may not provide the same level of cleanliness as a half tank flush for another toilet.

Thus, there is a need in the field to create an improved method and system to add multi-mode flush capability to a single mode flush toilet that is commonly available in households while adapting to the unique characteristics of different toilets. This invention provides such an improved method and system.

### BRIEF DESCRIPTION OF THE FIGURES

FIG. 1 is a representation of the preferred embodiments of the invention, shown with a conventional toilet.

FIGS. 2a, 2b, and 2c are representations of the flush selector of the preferred embodiments in orthogonal, back, and bottom views, respectively.

FIGS. 3a and 3b are a chart and graph, respectively, of the flush volume adjustment settings and actual flush time relationship of the preferred embodiments.

FIG. 4 is an orthogonal view of the water router and valve assembly of the preferred embodiments.

FIGS. 5a, 5b, and 5c are representations of the lifter of the preferred embodiments in an orthogonal view and two cross sectional views of the un-actuated and the actuated modes, respectively.

FIG. 6 is a representation of the lifter of the preferred embodiments, shown in a conventional toilet.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

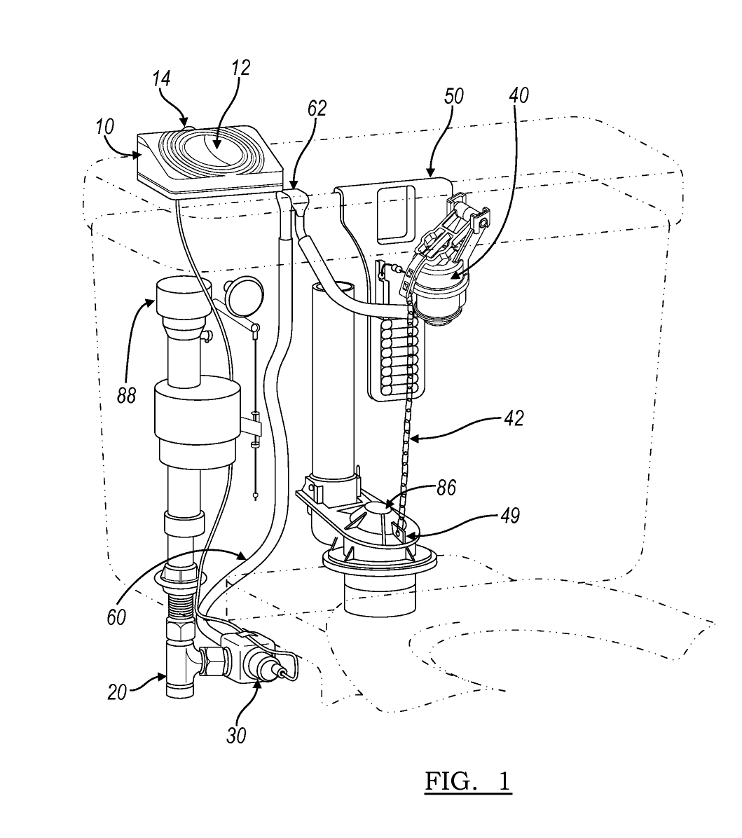

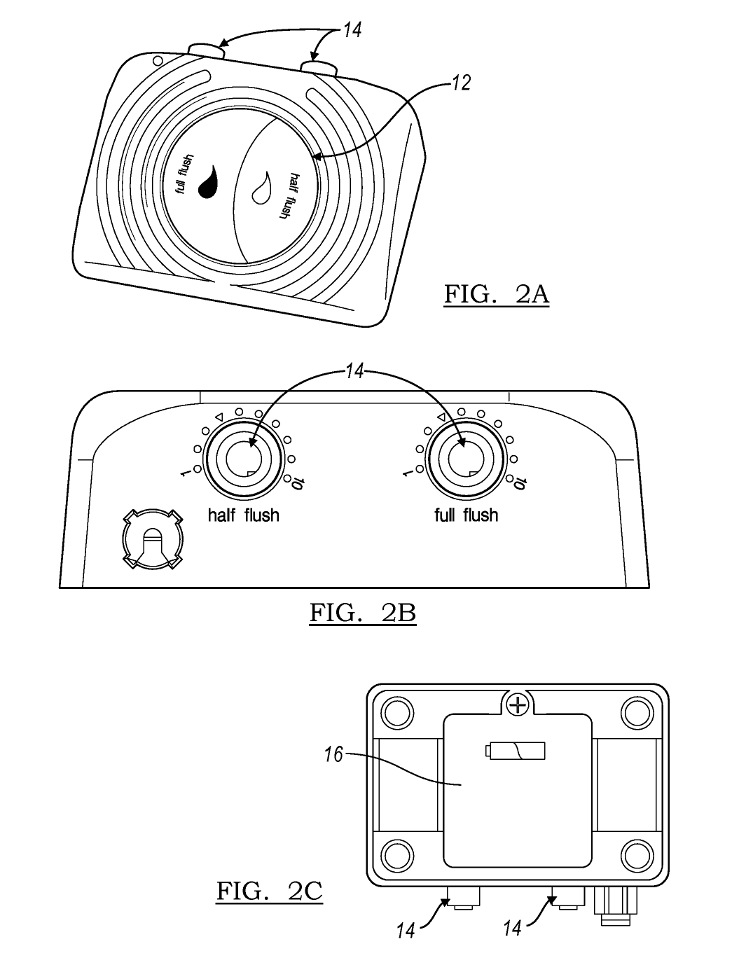

As shown in FIGS. 1 and 2, the system too of the preferred embodiments is preferably applied to a single-flush toilet system that includes a toilet bowl, a water tank coupled to water source that fills the water tank, and a flapper that allows water to flow from the water tank to the toilet bowl and to flush the toilet bowl. The system too preferably includes a flush selector to that allows user selection of at least two flush modes, a flush water volume adjuster 14 for each mode that allows the user to adjust the volume of water that flows from the water tank to flush the toilet bowl for each flush mode, a lifter 40 that lifts the flapper of the toilet and allows water to flow from the water tank to flush the toilet bowl, and a hydraulic power source 20 that powers the lifter 40 to allow the adjusted volume of water to flow from the water tank to the toilet bowl and to flush the toilet bowl. The system too may also include an alternative flapper 86 that is installed into the toilet system. The flush selector to is preferably also configured such that a user selection of a flush mode initiates a toilet flush. The system too may also include an attachment mechanism 50 to couple the system too to the toilet for installation.

The system too of the preferred embodiments may also include a processing unit that functions to detect, evaluate, and apply the user selection from the flush selector to and the flush volume adjuster 14 and/or to actuate a flush. The processing unit is preferably contained within the combined flush selector to and flush volume adjuster 14, allowing the system too to be a compact system that simplifies user installation. However, any other suitable arrangement of the processing unit may be used. The system too of the preferred embodiments may also include a power source 16. The power source 16 preferably provides the system too with adequate power to detect, evaluate, and apply the user selections received through the flush selector to and the flush volume adjuster 14 and/or to actuate a flush. The power source 16 is preferably a commonly available battery such as a AA battery, a AAA battery, or a 9V battery, but may alternatively be any other type of battery. The use of a battery type power source allows for increased mobility and flexibility in the installation of the system too. The power source 16 may alternatively be a connection to a wall outlet or a solar panel. However, any other suitable type of power source may be used

The system too of the preferred embodiments preferably allows a user to convert a single mode flush toilet system to a multi mode flush toilet system by providing the user with a means to select a flush mode through the flush selector to and to adjust the volume of water that flows from the water tank to flush the toilet through the flush volume adjuster 14. By allowing the user to adjust the volume of water that flows from the water tank to flush the toilet through the flush volume adjuster 14, the system too may accommodate to individual toilets and/or the preferences of the user.

The flush selector to of the preferred embodiments functions to allow the user selection to select from at least two different modes of flush. The first mode of flush is preferably a “full” flush, while the second mode of flush is preferably a “half” flush, where the volume of water that flows from the water tank to flush the toilet for the “full” flush mode is preferably higher than the volume of water that flows from the water tank to flush the toilet for the “half” flush mode. In this variation, the “half” flush mode is typically used to flush liquid wastes and the “full” flush mode is typically used to flush solid wastes. The number of modes and the type of modes may alternatively be of any other number or type suitable to regulating the flushing of the toilet. As shown in FIG. 2a, the flush selector 10 preferably includes a flush interface 12 that allows the user to select the desired mode of flush. The flush interface 12 preferably includes a push button for each mode of flush, as shown in FIG. 2a, but may alternatively be one push button that allows the user to select multiple modes of flush, for example, the user may push the button once for a first mode of flush and twice for a second mode of flush or the user may push the button for a longer period for a first mode of flush and push the button for shorter period for a second mode of flush. The flush interface 12 may alternatively be a lever that is moved from a first position to a second position by the user to actuate a flush, for example, the lever may be similar or a replacement for the flush lever as seen in typical toilets. There may be a first lever that the user may push to actuate a first mode of flush and a second lever that the user may push to actuate a second mode of flush. Alternatively, there may be a one lever that allows the user to select multiple modes of flush, for example, the user may lift the lever up to actuate a first mode and push the lever down to actuate a second mode. The user flush interface 12 may alternatively also be a touch screen that senses the location of the user input and correlates it to the mode of flush desired. The flush interface 12 may alternatively be a non-contact means of user interface such as a voice controlled interface, a motion sensor, a light sensor, or a sound sensor. However, any other suitable type of interface that allows the user to select their desired mode of flush may be used.

The flush volume adjuster 14 preferably allows the user to adjust the volume of water that flows from the water tank to flush the toilet bowl for each available mode of flush. As shown in FIG. 2b, the flush volume adjuster 14 is preferably fastened to the flush selector to such that the flush selector to and the flush volume adjustor 14 function as one physical unit. The combined flush selector to and flush volume adjuster 14 is then preferably arranged outside of the water tank after installation by the user. The flush volume adjuster 14 is preferably of a dial type, but may alternatively be buttons, sliders, or any other suitable user interface type. The system too preferably includes one flush volume adjuster 14 for each flush mode. However, any other suitable arrangement of the flush volume adjuster 14 may be used.

Each flush volume adjuster 14 preferably includes a plurality of settings that may be selected by the user and each of the settings preferably corresponds to a volume of water that flows from the water tank to flush the toilet bowl. To adjust the volume of water that flows from the water tank to flush the toilet bowl, the flush volume adjuster 14 preferably adjusts the length of time for which the lifter 40 lifts the flapper of the toilet in the open position, allowing the water to flow from the water tank to flush the toilet bowl. The correlation between the flush settings and the times for which the lifter 40 lifts the flapper of the toilet in the open position for each of the plurality of settings for the flush volume adjuster 14 is preferably based upon a study of common toilet types and user preferences. More specifically, the range of times for the flush settings is preferably determined by the range of time necessary to lift a flapper to adequately flush a common toilet. For example, in the case of the “half” flush mode, the range of time necessary to lift a flapper to adequately flush liquid waste is seen to be within the range from 0.2 seconds to 4.5 seconds among common toilet types and, accordingly, each of the flush volume settings for the “half” flush mode preferably correlate to a time within this range.

The times for each flush volume setting is preferably also based upon a study of common toilet types and user preferences. For example, in the case of the “half” flush mode, a substantially high number of common toilet types provide a clean flush when the flapper is held in the open position between 0.2 and 1 second and a substantially smaller number of common toilet types provide a clean flush out side of this range. Accordingly, the flush settings preferably provide higher resolution to adjust flapper lift time within the 0.2 and 1 second range while providing less resolution outside of the 0.2 and 1 second range (for example, from the 1 second to 4.5 second range). This allows the system 100 to tune adjustments to the volume of water that flows from the water tank to flush the toilet on two levels: a first level where the overall range of times to lift the flapper is determined by the range of times necessary to provide an adequate flush in common toilets, and a second level where the resolution of adjustments is determined common flapper lift times as seen among common toilets (or, in other words, determined by the frequency that the flapper lift times are seen among common toilets). The two levels may also alternatively be a first level that is conducted by the manufacturer of determining a common range of times and common times from within that range and a second level that is conducted by the user of selecting one of the common times provided by the manufacturer. Tuning adjustments on two levels may facilitate the system 100 to more efficiently and effectively adapting to unique characteristics of different toilets. However, any other suitable method to tune the adjustments to common toilets may be used.

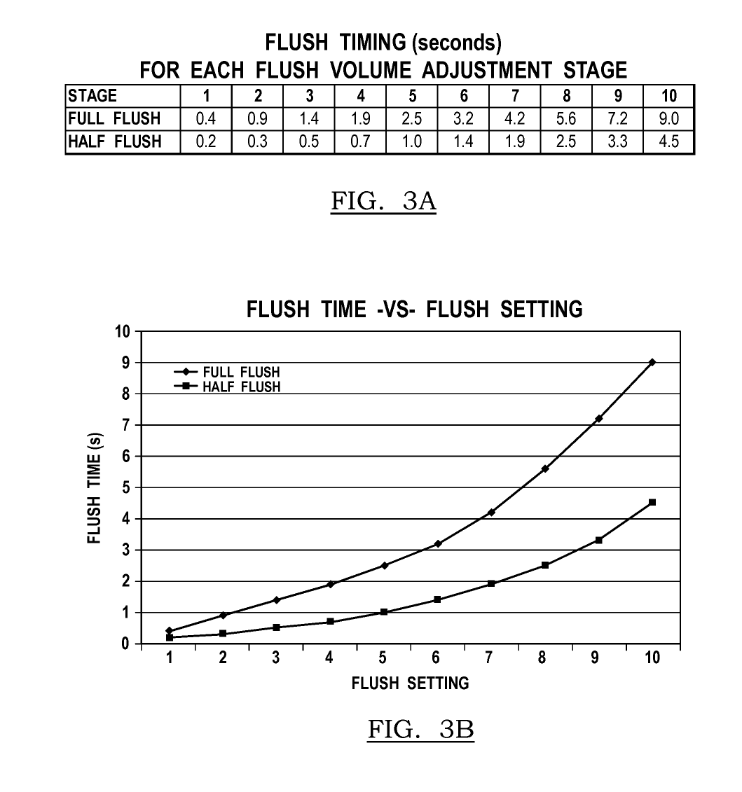

As shown in FIGS. 3a and 3b, because the times for each flush setting are preferably determined by characteristics as seen in common toilets, the times for each flush setting have a non-linear relationship. Additionally, the relationships between each of the settings of a first flush mode (for example, the “full” flush mode) and the corresponding setting of a second mode (For example, the “half” flush mode) are preferably different based upon the study of common toilet types and user preferences. For example, as shown in FIGS. 3a and 3b, the time for the first setting for the “full” flush mode is exactly twice that of the first setting for the “half” flush mode, while the time for the second setting for the “full” flush mode is more than twice that of the second setting for the “half” flush mode.

Alternatively, the flush volume adjuster 14 may allow the user to directly select the length of time or the volume of water for each mode of flush in any other suitable manner. For example, the times for each flush adjustment setting may be linearly related to each other (for example, positions 5, 6, and 7 on the flush adjuster 14 for the “full” flush may correlate to the lifter 40 holding the flapper open for 2, 4, 6 seconds respectively). In a second example, the flush volume adjuster 14 may alternatively be a button or any other suitable interface such that the length of time that the user pushes on the button directly correlates with the length of time/amount of water that the flapper is lifted in the open position. However, the time to lift the flapper may be determined using any other suitable method.

Alternatively, to adjust the volume of water that flows from the water tank to flush the toilet bowl, the flush volume adjuster 14 preferably adjusts the height to which the flapper is lifted. For example, for a higher volume flush, the flapper may be lifted to a high position, allowing a higher rate of flow of the fluid and/or more fluid to flow from the water tank to flush the toilet. For a lower volume flush, the flapper may be lifted to a position lower than the high position, decreasing the rate of flow of the fluid and/or decreasing the volume of fluid to flow from the water tank to flush the toilet. In this variation, the amount of time to lift the flapper at both the higher position and the lower position may be the same, allowing just the height to which the flapper is lifted to determine the volume of water that flows from the water tank to flush the toilet. Alternatively, the amount of time to lift the flapper at the higher position may be different from the amount of time to lift the flapper at the lower position. This variation allows lift time and height of the flapper to cooperate to determine the volume of fluid that flows from the water tank to flush the toilet. However, any other suitable volume adjustment may be provided.

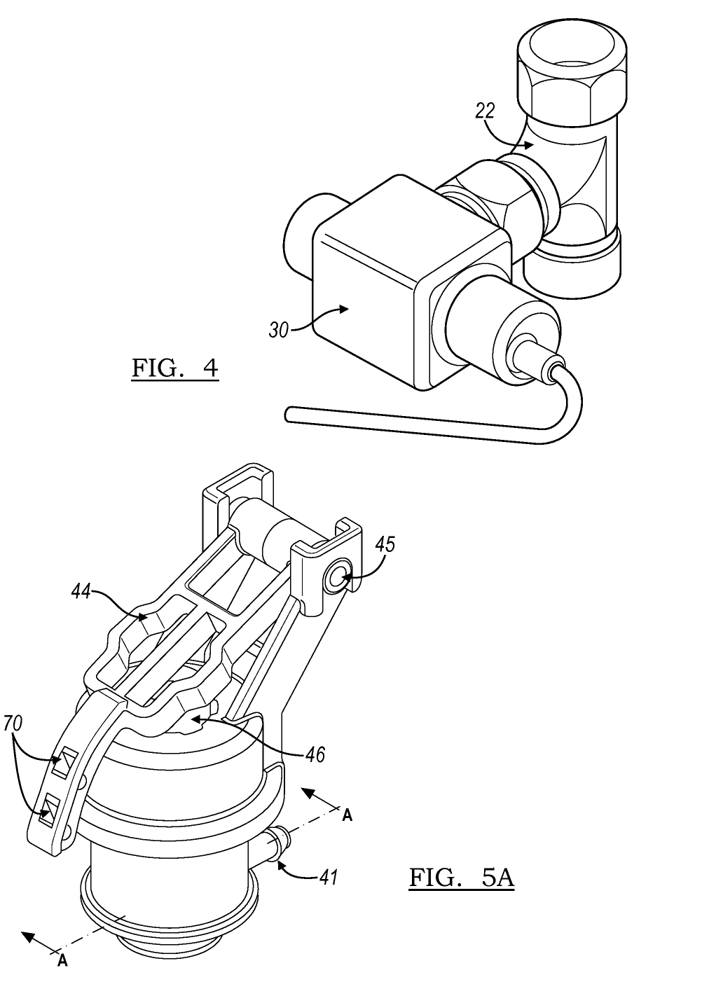

The hydraulic power source 20 is preferably the water source that fills the water tank. In this variation, the system 100 preferably includes a water router 22 that couples to the water source during installation of the system 100 and routes a portion of the water to power the lifter 40 and to fill the water tank and another portion of the water to fill the water tank. As shown in FIGS. 1 and 4, the water router 22 is preferably a “T” shaped pipe that is inserted in between the water source (for example, piping coming from the general piping system of the residence) and the lifter 40 and the water tank. In this variation, the system 100 may also include routing piping 60 that connects the water router 22 to the lifter 40. The water router 22 preferably also includes a valve 30 mounted between the water router 22 and the lifter 40 that allows water to flow to the lifter 40 to power the lifter to lift the flapper for the time corresponding to the flush setting selected by the user. The water router 22 preferably allows water to flow into the toilet water tank as in a typical toilet through the trunk of the “T” shaped pipe when the valve 30 is closed and allows a portion of the water to flow to power the lifter 40 through the branch of the “T” shaped pipe when the valve 30 is open. The “T” shaped pipe may be composed as a single piece and of a uniform material such as copper, stainless steel, rubber, or silicone, but may alternatively be a plurality of parts and of a plurality of materials. For example, the trunk of the “T” shaped pipe may be of a metal material, while the branch of the “T” shaped pipe may be of an elastomeric material that is coupled to the metal portion. However, any other suitable orientation and material of the “T” shaped pipe may be used. The water router 22 may alternatively be a “Y” shaped tube such that the piping from the wall is connected to the inlet of the “Y” pipe and one of the branches of the “Y” pipe is connected to the piping that allows water to flow into the toilet water tank and the other branch of the “Y” allows a portion of the water to flow to power the lifter 40. The water router 22 may also function to route all of the water flow from the water source to power the lifter 40. For example, the water router 22 an the valve 30 may cooperate to function to block the flow of water to the conventional toilet piping that allows water to flow into the toilet water tank when power to the lifter 40 is necessary and to allow water to flow to the conventional toilet piping that allows water to flow into the toilet water tank when power to the lifter 40 is not necessary. However, the water router 22 may be any other method, material, or geometry suitable to routing at least a portion of the water flow from the water source to power the lifter 40. Alternatively, the water router 22 may be coupled to the fill valve of the water tank. The fill valve may be the fill valve of the toilet system that is coupled to the water source and allows water from the water source to fill the water tank. In this variation, the water router 22 may couple to the fill valve to direct a portion of the fluid from the fill valve to the lifter 40 to power the lifter 40. The portion of fluid directed to power the lifter 40 is preferably then also used to fill the water tank. Alternatively, the fill valve may be an alternatively fill valve 88 that replaces the fill valve of the toilet system. In this variation, the water router 22 is preferably mounted to the alternative fill valve 88 to function as a single unit and is preferably installed into the toilet system as a single unit by the user. However, any other suitable arrangement of the water router 22 may be used.

As shown in FIGS. 1 and 4, the valve 30 is preferably a valve that is capable of holding at least two positions, an open position and a closed position. The closed position preferably prevents the flow of water from the water source to the lifter 40, and the open position preferably allows the flow of water from the water source to the lifter 40 (and, thereby, “power” the lifter 40) and to actuate the flush and allow the adjusted volume of water to flow from the water tank to the toilet bowl to flush the toilet bowl. The valve 30 preferably remains closed until a signal is received from the flush selector 10 and the flush volume adjuster 14 to actuate a flush. Once a signal is received, the valve 30 preferably transitions into the open position and to direct fluid to the lifter 40 to lift the flapper for the time corresponding to the selected flush volume setting. Once the time has elapsed, the valve 30 preferably returns to the closed state. The valve 30 preferably receives the signal through a wired connection, but may alternatively receive the signal from the flush selector 10 over a wireless connection. However, any other suitable method for receiving a signal from the flush selector 10 may be used. The valve 30 is preferably an electrically actuated valve (for example, a solenoid valve), but may alternatively be a pressure actuated valve or any other suitable valve type to control the water flow through the water router 30. As an example, the pressure actuation may be a direct pressure coupling between the flush interface 12 and the valve 30, such that the pressure provided by the user on the flush interface 12 is transferred to actuate the valve 30. In the variation wherein the valve 30 is electrically actuated, the actuation is preferably powered by the power source 16. However, the valve 30 may also include a power source. The valve 30 is preferably assembled to the water router 22 to function as one physical unit to simplify the installation of the system 100 by the user. A pre-assembled water router 22-valve 30 assembly also allows the manufacturer to control the manufacturing and reliability of the assembly. However, any other suitable arrangement of the valve 30 may be used.

The lifter 40 of the preferred embodiments functions to lift the flapper of the toilet into the open position to allow water to flow from the toilet water tank into the toilet bowl for a flush cycle. The lifter 40 also functions to return the flapper of the toilet to the closed position to prevent undesired water flow from the toilet water tank into the toilet bowl. As shown in FIG. 1, the lifter 40 is preferably fastened to the flapper of the toilet through a chain 42. The chain 42 is preferably fastened to the flapper where the conventional chain of the toilet would be fastened to the flapper, which facilitates the installation of the lifter 40 to an existing toilet. The chain 42 preferably replaces the original chain of the toilet that allowed the lever of the toilet to actuate the flush cycle, but the chain 42 may also be coupled to the flapper in addition to the original chain of the toilet, allowing a flush cycle to be actuated both by the user selecting a flush cycle through the flush selector 10 and by the user actuating the lever of the toilet as in a conventional toilet.

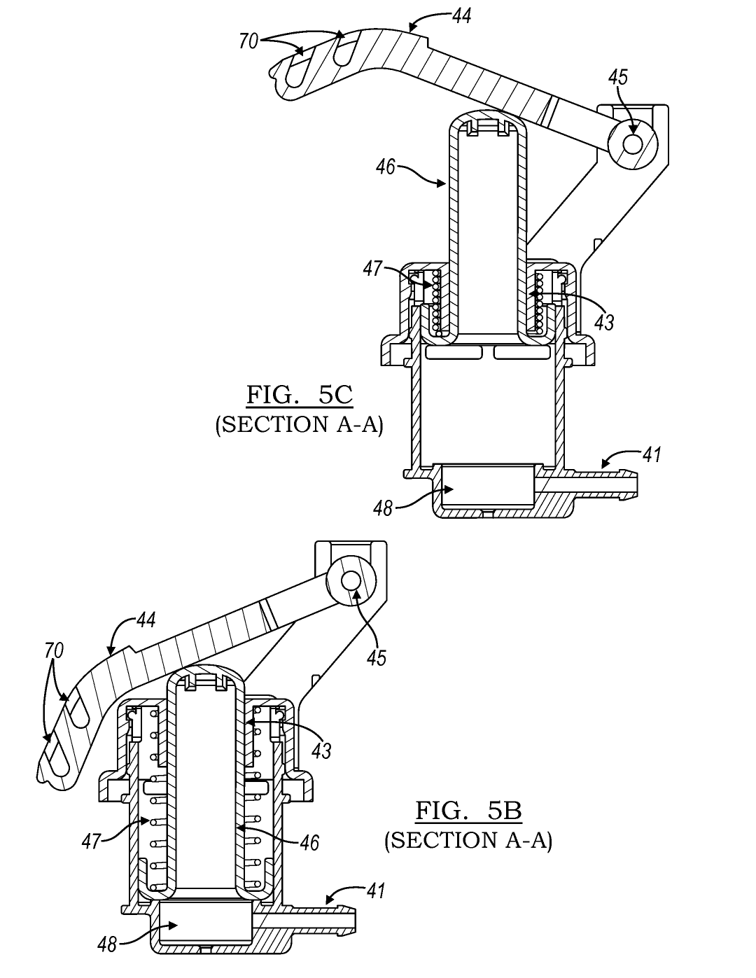

As mentioned above, the lifter 40 is preferably powered by water flow from the water source that fills the water tank. As shown in FIGS. 5a, 5b and 5c, the lifter 40 includes a water inlet 41, a vertical channel 43, a cavity 48 located below the channel 43 and coupled to the water inlet 41, an arm 44 coupled to the chain 42 and a pivot 45, and a piston 46. The arm 44 preferably includes a plurality of coupling points 70 to couple to the chain 42 at various heights to accommodate to the variety of common toilet geometries. To provide larger variations in height between the plurality of coupling points 70, the arm 44 preferably includes a substantially vertical portion 72 wherein the coupling points 70 are located. For example, a first coupling point 70 is preferably located at a first height along the vertical portion 72 and a second coupling point 70 is preferably located at a second height along the vertical portion 72, wherein the second height is lower than the first height. However, any other arrangement of the chain 42 relative to the arm 44 suitable to providing adjustability in the coupling of the chain 42 to the arm 44 may be used.

The piston 46 preferably at least partially resides in the channel 42, is in physical contact with the arm 44, and rests above the cavity 48. The piston 46 preferably translates vertically along the channel 43. As shown in FIG. 5b, the piston 46 is initially seated above the cavity 48 and the arm 44 is in a low position, allowing the flapper of the toilet to remain in the closed position. The piston 46 may also include a spring 47 that functions to bias the piston into the low position. As shown in FIG. 5c, once a user selection is detected by the flush selector 10, the valve 30 is switched to the open position and the water router 22 preferably routes water from the piping to flow through the water inlet 41 and into the cavity 48. The pressure resulting from the flowing water then lifts piston 46 within the channel 43 into a high position, allowing the piston 46 to push the arm 44 upwards. The arm 44 rotates about the pivot 45 and pulls on the chain 42, lifting the flapper of the toilet into the open position and allowing water to flow into the toilet bowl. The water flow lifting the piston 46 preferably then overflows from the cavity 48 through the channel 42 and into the water tank of the toilet to be used in the current or a future flush cycle. However, any other suitable arrangement or actuation method may be used for the lifter 40. For example, the arm 44 may be actuated electrically.

The lifter 40 is preferably made through an injection molding process using plastic, but may alternatively be made of any corrosion or rust resistant material. The lifter 40 may also be made using a combination of materials, for example, the arm 44 may be made of injection molded plastic while the spring 47 is made from brass. However, any other suitable material and manufacturing process made be used.

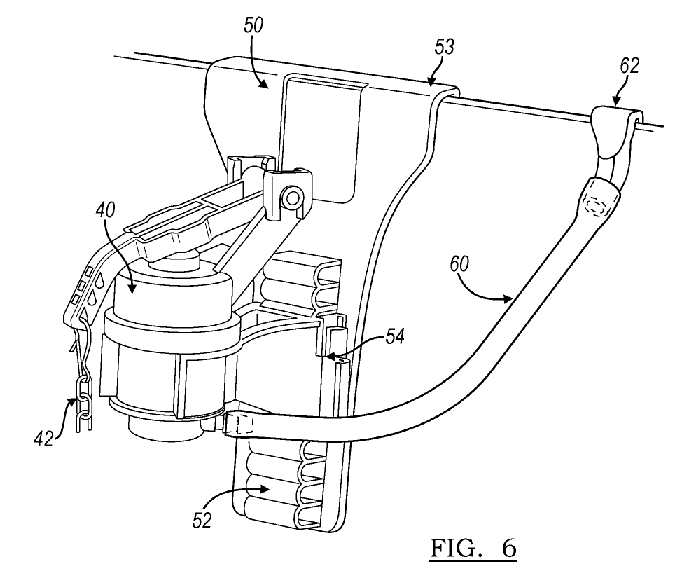

As mentioned above, the system 100 of the preferred embodiments may also include routing piping 60 that connects the water router 22 to the lifter 40. As shown in FIG. 1, the routing piping 60 is preferably coupled to the water router 22-valve 30 assembly and the water inlet 41 of the lifter 40, allowing the water that is rerouted by the water router 22 to flow into the lifter 40 to power the lifter 40. Because the lifter 40 is preferably located within the water tank of the toilet and the water router 22-valve 30 assembly is preferably located outside the water tank of the toilet in order to reroute water coming from the water source, the routing piping 60 partially resides outside of the water tank of the toilet and partial resides inside the water tank of the toilet. The routing piping 60 is preferably of pliable tubing such as latex, rubber, plastic, or any other suitable material, which allows the routing piping 60 to be placed in any orientation suitable to adapting to individual toilets. To adapt to different geometries between toilets, pliable routing piping 60 may also allow the user to shorten the routing piping 60 if necessary. Because the routing piping 60 preferably resides both inside and outside of the water tank of the toilet, a portion of the routing piping 60 is preferably positioned over the rim of the water tank of the toilet and kept in place by the cover of the water tank of the toilet. The preferred pliability of the routing piping 60 allows the cover of the water tank of the toilet to be placed over the routing piping 60 while in a position substantially similar to before the installation of the routing piping 60. Alternatively, the routing piping 60 may be split into a first section and a second section and may include a connector 62 that functions to connect the first section with the second section. The connector 62 is preferably substantially “U” shaped with a relatively small thickness, while allowing water flow between the first and second sections of the routing piping 60, as shown in FIGS. 1 and 6. The “U” shape of the connector 62 allows the connector 62 to attach to the wall of the water tank of the toilet and to secure the placement of the first section and the second section of the routing piping 60. The relatively small thickness of the connector 62 further allows the cover of the water tank of the toilet to be in a position substantially similar to the position before the installation of the routing piping 60. However, any other suitable geometry and placement of the connector 62 may be used.

The system 100 of the preferred embodiments may also include a weight 49 that counteracts the natural buoyancy of the flapper of the toilet and aides the lifter 40 in lifting the flapper of the toilet for a desired duration of time. Alternatively, the system 100 may include an alternative flapper 86 with relatively low or no buoyancy in water to replace the existing flapper of the toilet to facilitate the lifter 40 in controlling the flushing of the toilet. The weight 49 may be attached to the flapper at same the location where the chain 42 is attached, but may alternatively be attached to the flapper at a different location. For example, if the flapper of the toilet rotates about a hinge, the weight 49 may be more effective at counteracting the natural buoyancy of the flapper of the toilet if the weight 49 is placed substantially far from the hinge of the flap. In another example, if the flapper of the toilet includes a cavity that is accessible by the user, the weight 49 may be placed inside the cavity. However, any suitable arrangement of the weight 49 may be used. The weight 49 is preferably of a relatively high density material to minimize the volume of the weight 49, and is preferably of a material resistant to rust and corrosion (such as stainless steel or brass). However, the weight 49 may be of any other suitable type of material.

The system 100 of the preferred embodiments may also include an attachment mechanism 50 to couple the system 100 to the toilet for installation. As shown in FIGS. 1 and 6, the attachment mechanism 50 functions to hold the lifter 40 in a desired position. To simplify the installation of the system 100, the chain 42 is preferably of one length. Because of the variation in geometries in the water tanks of toilets, the relative position between the lifter 40 the flapper of the toilet may need to be adjusted to allow the chain 42 to be taut. If the chain 42 is not adequately taut, the lifter 40 may be less effective in lifting the flapper of the toilet into the open position and returning the flapper into the closed position. To accommodate the variation in toilet geometries, the attachment mechanism 50 is preferably adjustable. As shown in FIG. 6, the attachment mechanism 50 includes a ladder 52 and a ladder clamp 54. The ladder 52 preferably includes a stabilizer 53 that functions to couple the ladder 52 to the wall of the water tank of the toilet and the ladder 52 preferably remains stationary through the normal use of the system 100. The stabilizer 53 may be a hook (as shown in FIG. 6), but may alternatively be an adhesive that mounts the ladder 52 to the wall of the water tank of the toilet. The stabilizer 53 may be placed in any suitable position along the right, left, front, or back walls of the water tank of the toilet. However, any other structure or method suitable to couple the ladder 52 to the wall of the water tank of the toilet may be used. The ladder 52 may also be placed in any other location on the toilet suitable to allowing the lifter 40 to actuate the flapper of the toilet. The ladder clamp 54 is coupled to the lifter 40 and functions to engage the ladder 52 at various heights. The user is able to adjust the location of the ladder clamp 54 relative to the ladder 52 to accommodate to their toilet. The ladder clamp 54 preferably includes a clip that is selectively actuated by the user to couple to the ladder 52, but may alternatively be a clamp or a press fit geometry that couples to the ladder 52. The ladder clamp 54 preferably couples to the lifter 40 using a clamping mechanism, such as a c-clamp, and preferably allows the lifter 40 to rotate within the clamping mechanism. By allowing the lifter 40 to rotate, the lifter 40 may be oriented to best accommodate to the location of the flapper in the toilet. The clamping mechanism may also allow the lifter 40 to be adjusted vertically along the clamp, further accommodating to the variety of geometries seen in common toilets. However, any other structure or method to adjustably couple the lifter 40 to the ladder 52 may be used. Though the attachment mechanism 50 is preferably of the variations described above, any other structure or method suitable to stabilizing the lifter 40 relative to the flapper of the toilet while providing adjustability in placement of the lifter 40 may be used. The attachment mechanism 50 is preferably made through an injection molding process using plastic, but may alternatively be made of any corrosion or rust resistant material. However, any other suitable material and manufacturing process made be used.

As a person skilled in the art will recognize from the previous detailed description and from the figures and claims, modifications and changes can be made to the preferred embodiments of the invention without departing from the scope of this invention defined in the following claims.

We claim:

1. A system to convert a single flush toilet system to a multi-flush toilet system, wherein the toilet system includes a toilet bowl, a water tank coupled to a water source that fills the water tank, and a flapper that allows water to flow from the water tank to the toilet bowl and to flush the toilet bowl, comprising:
a flush selector that allows user selection of at least two flush modes;
a flush water volume adjuster for each flush mode that allows the user to adjust the volume of water that flows from the water tank to flush the toilet bowl for each flush mode;
a lifter that lifts the flapper of the toilet and allows water to flow from the water tank to flush the toilet bowl;
a hydraulic power source that powers the lifter to allow the adjusted volume of water to flow from the water tank to the toilet bowl and to flush the toilet bowl.

2. The system of claim 1, wherein the flush selector is configured such that a user selection of a flush mode initiates a toilet flush.

3. The system of claim 1, wherein the flush selector includes a first mode with a high volume flush and a second mode with a low volume flush, wherein the volume of water that flows from the water tank to flush the toilet bowl is higher in the first mode than the second mode.

4. The system of claim 1, wherein the flush water volume adjuster is fastened to the flush selector.

5. The system of claim 1, wherein the flush water volume adjuster includes a plurality of settings of flush water volume adjustment for each mode, wherein each of the settings are selectable by a user, and wherein each of the plurality of settings correspond to a volume of water that flows from the water tank to flush the toilet bowl.

6. The system of claim 5, wherein the relationship between a first, second, and third setting of a mode is non-linear.

7. The system of claim 5, wherein the relationship between a first setting for a first mode and a first setting for a second mode and the relationship between a second setting for the first mode and a second setting for the second mode are different.

8. The system of claim 5, wherein each of the plurality of settings correspond to a time to lift the flapper to allow a volume of water to flow from the water tank to flush the toilet bowl.

9. The system of claim 8, wherein the time to lift the flapper corresponding to each of the plurality of settings is determined on two levels: a first level wherein the range of time corresponding to the plurality of settings is determined and a second level wherein the time corresponding to each of the plurality of settings is determined.

10. The system of claim 9, wherein range of time corresponding to the plurality of settings is determined based upon the range of time to lift the flapper as seen in common toilets and wherein the time corresponding to each of the plurality of settings is determined by the frequency of times to lift the flapper as seen in common toilets.

11. The system of claim 10, wherein the difference between the time of a first setting and the time of a second setting is smaller than the difference between the time of the second setting and the time of a third setting, wherein the first, second, and third settings are consecutive settings.

12. The system of claim 10, wherein a first, second, third, fourth, fifth, sixth, seventh, eighth, ninth, and tenth setting for a mode corresponds to lifting the flapper for 0.4, 0.9, 1.4, 1.9, 2.5, 3.2, 4.2, 5.6, 7.2, and 9.0 seconds, respectively.

13. The system of claim 10, wherein a first, second, third, fourth, fifth, sixth, seventh, eighth, ninth, and tenth setting for a mode corresponds to lifting the flapper for 0.2, 0.3, 0.5, 0.7, 1.0, 1.4, 1.9, 2.5, 3.3, and 4.5 seconds, respectively.

14. The system of claim 1, wherein the hydraulic power source is the water source, and wherein the water that fills the water tank to flush the toilet bowl lifts the lifter.

15. The system of claim 14, further comprising a water router coupled to the water source that routes a portion of the water to power the lifter and to fill the water tank and another portion of the water to fill the water tank.

16. The system of claim 15, wherein the water router is piping that includes three ends, a first end coupled to the water source, a second end coupled to the water tank, and a third end coupled to the lifter, further comprising a valve mounted to the third end of the water router that allows water to flow to the lifter to power the lifter and the adjusted volume of water to flow from the water tank to the toilet bowl and to flush the toilet bowl.

17. The system of claim 16, wherein the valve is electrically actuated.

18. A system to convert a single flush toilet system to a multi-flush toilet system, wherein the toilet system includes a water tank that is coupled to a water source that fills the water tank, and a toilet bowl, comprising:
a flapper that allows water to flow from the water tank to the toilet bowl and to flush the toilet bowl;
a flush selector that allows user selection of at least two flush modes;
a flush water volume adjuster for each flush mode that allows the user to adjust the volume of water that flows from the water tank to flush the toilet bowl for each mode;
a lifter coupled to the flapper that lifts the flapper of the toilet and allows water to flow from the water tank to flush the toilet bowl; and
a hydraulic power source that powers the lifter to allow the adjusted volume of water to flow from the water tank to the toilet bowl and to flush the toilet bowl.

19. The system of claim 18, wherein the flush water volume adjuster includes a plurality of settings of flush water volume adjustment for each mode, wherein each of the plurality of settings correspond to a time to lift the flapper to allow a volume of water to flow from the water tank to flush the toilet bowl.

20. A method to convert a single flush toilet system to a multi-flush toilet system, wherein the toilet system includes a water tank that is coupled to a water source that fills the water tank, a toilet bowl, and a flapper that allows water to flow from the water tank to the toilet bowl and to flush the toilet bowl, comprising the steps of:
providing a flush selector that allows user selection of at least two flush modes;
allowing the user to adjust the volume of water that flows from the water tank to flush the toilet bowl for each mode;
lifting the flapper to allow water to flow from the water tank to flush the toilet bowl; and
routing hydraulic power to lift the flapper to allow the adjusted volume of water to flow from the water tank to the toilet bowl and to flush the toilet bowl.

21. The method of claim 20, wherein the step of allowing the user to adjust the volume of water used to flush the toilet bowl for each flush mode includes allowing the user to adjust a time to lift the lifter to allow a volume of water to flow from the water tank to flush the toilet bowl for each mode, and wherein the step of routing hydraulic power to lift the flapper to allow adjusted volume of water to flow from the water tank to flush the toilet bowl includes the step of lifting the flapper for the adjusted time.
